(19) United States
(12) Patent Application Publication
(10) Pub. No.: US 2024/0195692 A1
(43) Pub. Date: Jun. 13, 2024

(54) NETWORK MANAGEMENT APPARATUS, NETWORK MANAGEMENT METHOD AND NETWORK MANAGEMENT SYSTEM

(71) Applicant: RAKUTEN MOBILE, INC., Tokyo (JP)

(72) Inventors: David LIEW, Tokyo (JP); Rion KIMURA, Tokyo (JP)

(73) Assignee: RAKUTEN MOBILE, INC., Tokyo (JP)

(21) Appl. No.: 17/907,861

(22) PCT Filed: Jan. 17, 2022
(86) PCT No.: PCT/JP2022/001319

§ 371 Date: Aug. 29, 2022

(51) Int. Cl. H04L 41/08; H04L 41/082; H04L 41/147; H04L 41/16

(52) U.S. Cl. CPC H04L 41/0886; H04L 41/082; H04L 41/147; H04L 41/16

(57) ABSTRACT

Disclosed herein is a network management apparatus, comprising: a change request acquisition unit configured to acquire a change request that describes information on contents of a change plan relating to a network configuration; a first determination unit configured to determine, based on the information included in the change request, whether or not to perform an automatic approval that approves the change request without notifying an approver of the change request; a risk assessment unit configured to assess, based on the information included in the change request, a risk of implementing a change in accordance with the change request; and a second determination unit configured to determine whether or not to perform the automatic approval based on the risk assessed by the risk assessment unit with respect to the change request for which the automatic approval has not been determined to be performed by the first determination unit.

### TECHNICAL FIELD

The present invention relates to a network management apparatus, a network management method, and a network management system, and in particular to a technique for automating an approval process responsive to a change request.

### BACKGROUND ART

With a background of improved performance of general-purpose servers and network infrastructures, cloud computing (hereinafter simply referred to as “cloud”), which on demand uses computing resources that are virtualized on physical resources such as servers, has become widely prevailing. In addition, the Network Function Virtualization (NFV), which virtualizes network functions and provides the virtualized network functions on the cloud, has been well known. The NFV is a technology that uses virtualization and cloud technologies to separate the hardware and software of various network services, which used to run on dedicated hardware, and to run the software on a virtualized infrastructure. It is expected to improve the sophistication of operations and reduce costs by use of those virtualization technologies.

In recent years, the virtualization has been advanced in mobile networks as well.

The European Telecommunications Standards Institute (ETSI) NFV defines the NFV architecture (see, for example, Patent Literature 1).

### LISTING OF REFERENCES

### Patent Literature

PATENT LITERATURE 1: International Publication of PCT International Patent

### SUMMARY OF THE INVENTION

### Problems to be Solved by the Invention

Recent telecom networks are large-scale networks that have been constituted with a large number of devices and functions. In operating and maintaining such a large-scale network, it is frequently required to repair or replace various devices and functions that constitute a production environment, which is an actual operating environment.

Conventionally, when changes are made to the production environment, certain processes have been followed where an approver will approve change requests that have been submitted or raised before implementing the approved changes. However, the approver is required to appropriately assess risks associated with the change, and correctly determine whether nor the content and procedures of the change are appropriate before approving the change request. In addition, since risk assessment requires multifaceted verification from various perspectives, responsible persons from multiple departments have been brought together, and approvals have been performed in multiple stages by multiple approvers.

As mentioned above, manually approving change requests inevitably requires a great deal of time and labor, which may also lead to network failures due to human errors in approving change requests.

The present invention has been made in order to solve the above mentioned problems and an object thereof is to provide a network management apparatus, a network management method, and a network management system capable of reducing the time and human cost required for approving change requests in a large-scale network.

### Solution to Problems

In order to solve the above mentioned problems, according to one aspect of the present invention, there is provided a network management apparatus, comprising: a change request acquisition unit configured to acquire a change request that describes information on contents of a change plan relating to a network configuration; a first determination unit configured to determine, based on the information included in the change request acquired by the change request acquisition unit, whether or not to perform an automatic approval that approves the change request without notifying an approver of the change request; a risk assessment unit configured to assess, based on the information included in the change request acquired by the change request acquisition unit, a risk of implementing a change in accordance with the change request; and a second determination unit configured to determine whether or not to perform the automatic approval based on the risk assessed by the risk assessment unit with respect to the change request for which the automatic approval has not been determined to be performed by the first determination unit.

The network management apparatus may further comprise: an approval performing unit configured to perform an approval of the change request for which the automatic approval is determined to be performed by the first determination unit or the second determination unit; and a notification unit configured to notify an approver of the change request for which the automatic approval has been determined not to be performed by the second determination unit.

The first determination unit may determine to perform the automatic approval when the change request acquired by the change request acquisition unit is the same as or similar to a change request for which approval has been performed previously.

The network management apparatus may further comprise: a learning unit configured to train a learning model to learn the change request for which the approval has been performed, and the first determination unit may determine whether or not to perform the automatic approval using the learning model trained by the learning unit.

The risk assessment unit may assess the risk in at least two levels: high risk and low risk, and the second determination unit may determine to perform the automatic approval when the risk level of the change request for which the automatic approval has not been determined to be performed by the first determination unit is low risk, and determine not to perform the automatic approval when the risk level of the change request for which the automatic approval has not been determined to be performed by the first determination unit is high risk.

The risk assessment unit may assess the risk in three levels: high risk, medium risk, and low risk, and when the risk level of the change request for which the automatic approval has not been determined to be performed by the first determination unit is medium risk, the second determination unit may further determine whether or not the change request is the same as or similar to a change request that has been previously acquired by the change request acquisition unit, and determine to perform the automatic approval when the change request is determined to be the same as or similar to the change request that has been previously acquired, and determine not to perform the automatic approval when the change request is determined to be neither the same nor similar to the change request that has been previously acquired.

The risk assessment unit may assess the risk based on at least one of the following: an impact of implementing the change on a service, time of day when the change is implemented, availability of a rollback function, and availability of backups.

According to another aspect of the present invention, there is provided a network management method performed by a network management apparatus, comprising: an acquiring step of acquiring a change request that describes information on contents of a change plan relating to a network configuration; a first determination step of determining, based on the information included in the acquired change request, whether or not to perform an automatic approval that approves the change request without notifying an approver of the change request; an assessment step of assessing, based on the information included in the acquired change request, a risk of implementing a change in accordance with the change request; and a second determination step of determining whether or not to perform the automatic approval based on the risk assessed in the assessment step with respect to the change request for which the automatic approval has not been determined to be performed in the first determination step.

According to yet another aspect of the present invention, there is provided a network management system, comprising: a change request acquisition unit configured to acquire a change request that describes information on contents of a change plan relating to a network configuration; a first determination unit configured to determine, based on the information included in the change request acquired by the change request acquisition unit, whether or not to perform an automatic approval that approves the change request without notifying an approver of the change request; a risk assessment unit configured to assess, based on the information included in the change request acquired by the change request acquisition unit, a risk of implementing a change in accordance with the change request; and a second determination unit configured to determine whether or not to perform the automatic approval based on the risk assessed by the risk assessment unit with respect to the change request for which the automatic approval has not been determined to be performed by the first determination unit.

### Advantageous Effect of the Invention

According to the present invention, it makes it possible to reduce the time and human cost required for approving change requests in a large-scale network.

The above mentioned and other not explicitly mentioned objects, aspects and advantages of the present invention will become apparent to those skilled in the art from the following embodiments (detailed description) of the invention by referring to the accompanying drawings and the appended claims.

### BRIEF DESCRIPTION OF DRAWINGS

FIG. 1 is a conceptual diagram illustrating an exemplary network configuration of a mobile network including a network management apparatus according to the present embodiment.

FIG. 2 is a block diagram illustrating an exemplary internal configuration of a network management system.

FIG. 3 is a block diagram illustrating an exemplary functional configuration of a network management section.

FIG. 4 is a flowchart illustrating an exemplary processing procedure of automatic approval determination processing.

FIG. 5 is a schematic diagram illustrating an exemplary risk assessment table.

FIG. 6 is a schematic diagram illustrating an example of notification patterns to approvers.

FIG. 7 is a schematic diagram illustrating an exemplary flow of the automatic approval determination processing.

FIG. 8 is a comparable diagram illustrating conventional processes of implementing change requests.

FIG. 9 is a schematic diagram illustrating an exemplary hardware configuration of the network management apparatus.

### DESCRIPTION OF EMBODIMENTS

Hereinafter, embodiments of the present invention will be described in detail with reference to the accompanying drawings. Among the constituent elements disclosed herein, those having the same function are denoted by the same reference numerals, and a description thereof is omitted. It should be noted that the embodiments disclosed herein are illustrative examples as means for implementing the present invention, and should be appropriately modified or changed depending on a configuration and various conditions of an apparatus to which the present invention is applied, and the present invention is not limited to the following embodiments. Furthermore, it should be noted that all of the combinations of features described in the following embodiments are not necessarily essential to the solution of the present invention.

Hereinafter, a non-limiting example will be described in which a network management apparatus according to the present embodiment has a network management function that automates the approval processes responsive to a change request (CR) in a mobile network constructed on a virtualized infrastructure.

Here, the change request is referred to as a request that describes information on the contents of a change plan relating to a network configuration. The change requests are assumed to be submitted or raised to implement changes such as repairs, replacements, or updates to various devices and functions that constitute the mobile network.

The change requests may include information on the priority level of the change, whether the change impacts services, the domain of the change (e.g., infrastructure, platform, and the like), the target cluster (e.g., all PODs, some PODs, and the like), the contents or nature of the change (e.g., software upgrade, hardware replacement, workaround (WA), and the like), the schedule of the change (e.g., during maintenance hours, daytime, nighttime, and the like), the event (e.g., network outages, national events, service outages, natural disasters, and the like), and change procedures (e.g., availability of rollback procedures, availability of backup procedures), and the like.

According to the present embodiment, the network management apparatus determines whether or not to perform an automatic approval, which approves the change request without notifying an approver of the change request, based on the information included in the change request and the risk assessment against the circumstance of implementing the change in accordance with the change request.

More specifically, the network management apparatus first determines whether or not to perform the automatic approval based on the information included in the change request, and for change requests for which the automatic approval is not determined to be performed immediately, the network management apparatus further conducts a risk assessment and determines whether or not to perform the automatic approval based on the results of the above risk assessment. Subsequently, for change requests for which the automatic approval is determined to be performed post to the risk assessment, the network management apparatus automatically performs the approval without notifying an approver of the change request, while for change requests for which the automatic approval is determined not to be performed post to the risk assessment, the network management apparatus notifies the approver of the change request to request a manual approval from the approver.

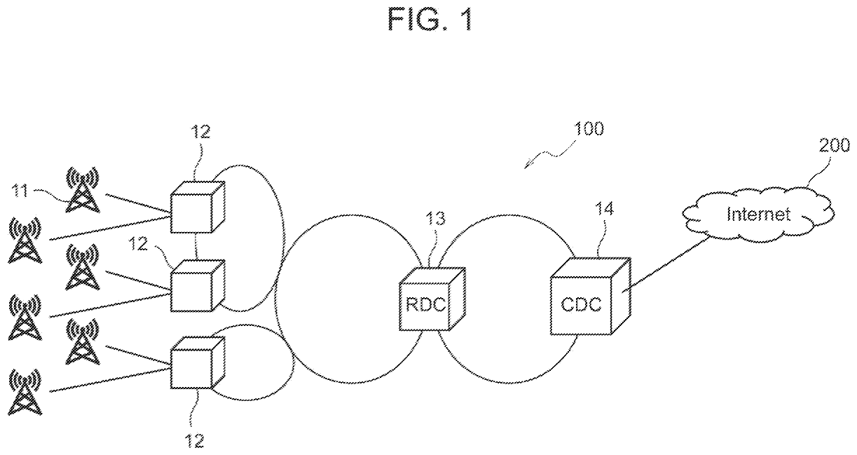

FIG. 1 is a conceptual diagram illustrating an exemplary network configuration of a mobile network 100 including a network management apparatus according to the present embodiment.

In the mobile network 100 shown in FIG. 1, a terminal capable of mobile communication such as a smartphone and the Radio Access Network (RAN) communicate with each other wirelessly, and the transmitted information is relayed through the backhaul network (i.e., Mobile Backhaul: MBH) to the core network for processing. This allows the mobile communication terminal to connect to the Internet 200 or connect to another company's network to make voice calls, or the like.

More specifically, the mobile network 100 includes base stations 11 and a plurality of accommodating stations 12 to 14. In FIG. 1, the accommodating station 12 is an edge data center, the accommodating station 13 is a Regional Data Center (RDC), and the accommodating station 14 is a Central Data Center (CDC). A backhaul network is constituted between the edge data center 12 and the central data center 14.

The mobile network 100 according to the present embodiment may be a virtualized network constructed on a virtualization infrastructure. The mobile network 100 realizes everything from the switching equipment of the backbone network to the radio access functions of the base stations by software on general-purpose servers.

The base station 11 is equipped with an antenna, a switchboard, a battery, and the like.

The edge data center 12 is located near the base stations 11 and is connected to a plurality of base stations 11 via fiber-optic cables, or the like. The edge data center 12 realizes the RAN-related radio access functions.

The regional data center 13 is connected to a plurality of edge data centers 12. The regional data center 13 realizes various applications by software, for the firewall/NAT (Network Address Translation), the CDN (Content Distribution Network), and edge computing.

The central data center 14 is connected to a plurality of regional data centers 13. The central data center 14 realizes core functions such as the EPC (Evolved Packet Core), the IMS (IP Multimedia Subsystem), or the like.

It should be noted that the number of respective data centers (i.e., accommodating stations), that is, the edge data center 12, the regional data center 13, and the central data center 14, is not limited to the number shown in FIG. 1. For example, although only one regional data center 13 and one central data center 14 are shown in FIG. 1, there may be a plurality of regional data centers 13 and central data centers 14, respectively.

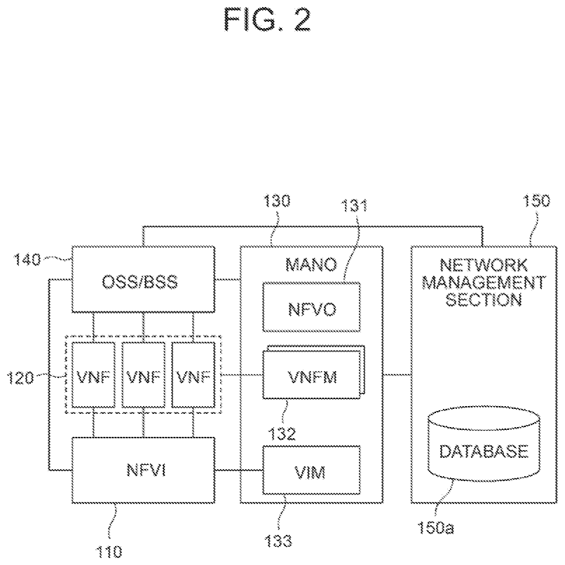

FIG. 2 is a block diagram illustrating an exemplary internal configuration of a network management system that constitutes the mobile network 100.

Each of constituent elements shown in FIG. 2 has a reference point. The lines connecting the constituent components shown in FIG. 2 indicate that connected constituent elements can send and receive information with each other.

The NFVI (NFV Infrastructure) 110 is a network function virtualization infrastructure, and includes physical resources, a virtualization layer, and virtualized resources. The physical resources include hardware resources such as computing resources, storage resources, and transmission resources. The virtualization layer is a virtualizing layer such as a hypervisor for virtualizing the physical resources and providing the virtualized physical resources to the VNF (Virtual Network Function) 120. The virtualized resources are the virtualized infrastructure resources provided to the VNF 120.

In other words, the NFVI 110 is an infrastructure that enables flexible handling of hardware resources of physical servers (hereinafter also simply referred to as “servers”), such as computing, storage, and network functions, and renders these hardware resources into virtualized hardware resources such as virtualized computing, virtualized storage, and virtualized network, which are virtualized by the virtualization layer such as the hypervisor.

A plurality of servers that constitute the NFVI 110 are grouped together and deployed in each of the data centers 12 to 14. The number, the placement positions, wiring, and the like, of the servers to be deployed in each of the data centers 12 to 14 are predetermined depending on the type of data center (i.e., accommodating station type). In each of the data centers 12 to 14, the deployed servers are connected by an internal network and are capable of sending and receiving information from each other. In addition, the data centers are connected to each other by a network, and the servers in different data centers are capable of sending and receiving information from each other via the network.

The VNF 120 corresponds to applications running on virtual machines (VMs) on the servers and implements the network functions by software. Although not specifically shown, each VNF 120 may be provided with a management function called an EM (Element Manager).

The NFVI 110 and the VNF 120 in FIG. 2 constitute the virtualized environment. In other words, the virtualized environment is constituted with three layers, in the bottom-up order namely: the hardware, the virtualization layer, and virtual machines.

The MANO (Management and Orchestration) 130 has management and orchestration functions for the virtualized environment. The MANO 130 includes the NFVO (NFV-Orchestrator) 131, the VNFM (VNF-Manager) 132, and the VIM (Virtualized Infrastructure Manager) 133.

The NFVO 131 orchestrates the NFVI resources, manages the lifecycle of network services, and provides integrated operational management of the entire system. The NFVO 131 is capable of performing processing in response to instructions from the OSS/BSS (Operation Support System/Business Support System) 140, which will be described below.

The VNFM 132 manages the lifecycle of each of the VNFs 120. It should be noted that the VNFM 132 may be arranged in the MANO 130 as a dedicated VNFM corresponding to each of the VNFs 120. Alternatively, a single VNFM 132 may manage the lifecycle of two or more VNFs 120. In this case, the VNFM 132 may be a general-purpose VNFM that supports VNFs 120 provided by different vendors.

The VIM 133 performs operational management of the resources used by the VNFs 120.

The OSS/BSS 140 is an integrated management system for the mobile network 100.

Here, the OSS is a system (i.e., equipment, software, mechanism, and the like) necessary for constructing and operating the desired services, and the BSS is an information system (i.e., equipment, software, mechanism, and the like) used for billing, invoicing, and customer services.

The network management section 150 performs the network management function that acquires change requests that have been submitted and determines whether or not to perform an automatic approval of the acquired change requests. The network management section 150 serves as the network management apparatus according to the present embodiment.

The network management section 150 is equipped with a database 150a. The database 150a stores information included in change requests that have been previously acquired. For example, the database 150a is able to store information included in change requests that have been previously acquired, and preceding to the storing step to associate the same with other information (such as flags) indicating whether or not an approval has been previously performed.

The network management section 150 is able to refer to the database 150a based on the information included in the acquired change request and determine whether or not the acquired change request is the same as or similar to a change request that has been previously acquired. The network management section 150 is also able to refer to the database 150a based on the information included in the acquired change request and determine whether or not the acquired change request is the same as or similar to a change request for which approval has been previously performed.

In the following description, a change request that is the same as or similar to a change request that has been previously acquired is referred to as “N^{th} CR”, and any other change request is referred to as “first CR”. In addition, a change request that is the same as or similar to a change request for which approval has been previously performed is referred to as “routine CR” and any other change request is referred to as “non-routine CR”.

It should be noted that the network management section 150 is not limited to the case in which the network management section 150 is an external function of the OSS/BSS 140 or the MANO 130, as shown in FIG. 2. The network management section 150 may be provided inside the OSS/BSS 140 or the MANO 130. In this case, the network management function of the network management section 150 becomes a part of the functions of the OSS/BSS 140 or the MANO 130.

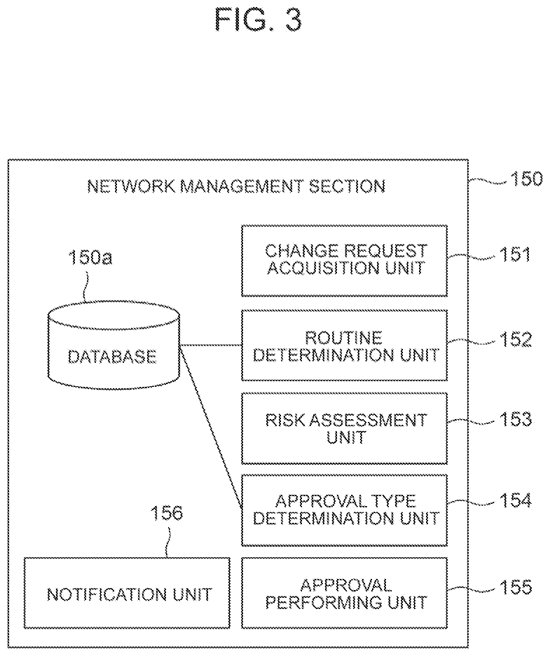

FIG. 3 is a block diagram illustrating an exemplary functional configuration of the network management section 150.

As shown in FIG. 3, the network management section 150 includes a change request acquisition unit 151, a routine determination unit 152, a risk assessment unit 153, an approval type determination unit 154, an approval performing unit 155, and a notification unit 156.

The change request acquisition unit 151 acquires a change request that has been submitted.

The routine determination unit 152 determines, based on the information included in the change request acquired by the change request acquisition unit 151, whether or not the change request concerned is a routine CR.

The risk assessment unit 153 assesses the risk of implementing the change in accordance with the change request based on the information included in the change request acquired by the change request acquisition unit 151. According to the present embodiment, an exemplary case will be described in which the risk assessment unit 153 assesses the risk in three levels: high risk, medium risk, and low risk.

The approval type determination unit 154 determines whether or not to perform an automatic approval, which automatically approves the change request acquired by the change request acquisition unit 151 without notifying an approver, based on the results of the determination by the routine determination unit 152 and the results of the assessment by the risk assessment unit 153.

More specifically, the approval type determination unit 154 determines to perform the automatic approval when the change request is determined to be the routine CR by the routine determination unit 152.

On the other hand, for change requests that are determined as other than the routine CR, in other words, change requests for which the automatic approval is not determined to be performed, the approval type determination unit 154 determines whether or not to perform the automatic approval based on the risk assessed by the risk assessment unit 153.

More specifically, the approval type determination unit 154 determines to perform the automatic approval when the above risk is low, while the approval type determination unit 154 determines not to perform the automatic approval when the above risk is high. When the above risk is medium, the approval type determination unit 154 further determines whether or not the change request is an N^{th} CR. Then the approval type determination unit 154 determines to perform the automatic approval when the change request is determined to be N^{th} CR, while the approval type determination unit 154 determines not to perform the automatic approval when the change request is determined to be a first CR.

The approval performing unit 155 performs an approval of a change request when the automatic approval is determined to be performed by the approval type determination unit 154. For example, the approval performing unit 155 may send information on the change request for which the automatic approval is determined to be performed by the approval type determination unit 154 to a change implementing unit to implement the change, which is not shown. The change implementing unit may be provided in the network management section 150, or alternatively, may be provided in any external device that is separate from the network management section 150. The approval performing unit 155 may also notify an implementer who implements the change of the change request for which the automatic approval is determined to be performed by the approval type determination unit 154, as an approved change request.

The notification unit 156 notifies an approver of a change request for which the automatic approval is determined not to be performed by the approval type determination unit 154. The ways of notifying the approver are not particularly limited, as long as the ways of notification enable an approver to check or confirm the contents of the change request.

It should be noted that the configuration of the functional blocks of the network management section 150 shown in FIG. 3 is no more than an example, and multiple functional blocks may constitute one functional block, or any of the functional blocks may be divided into blocks that perform multiple functions. For example, the approval type determination unit 154 may be divided into two blocks: a first determination unit that determines whether or not to perform an automatic approval based on the results of the determination by the routine determination unit 152; and a second determination unit that determines, for change requests for which the automatic approval is not determined to be performed by the first determination unit, whether or not to perform the automatic approval based on the risk assessed by the risk assessment unit 153.

The multiple functions of the network management section 150 may be divided into the external functions of the OSS/BSS 140 or the MANO 130, the internal functions of the OSS/BSS 140, and the internal functions of the MANO 130 of the network management system shown in FIG. 2, respectively.

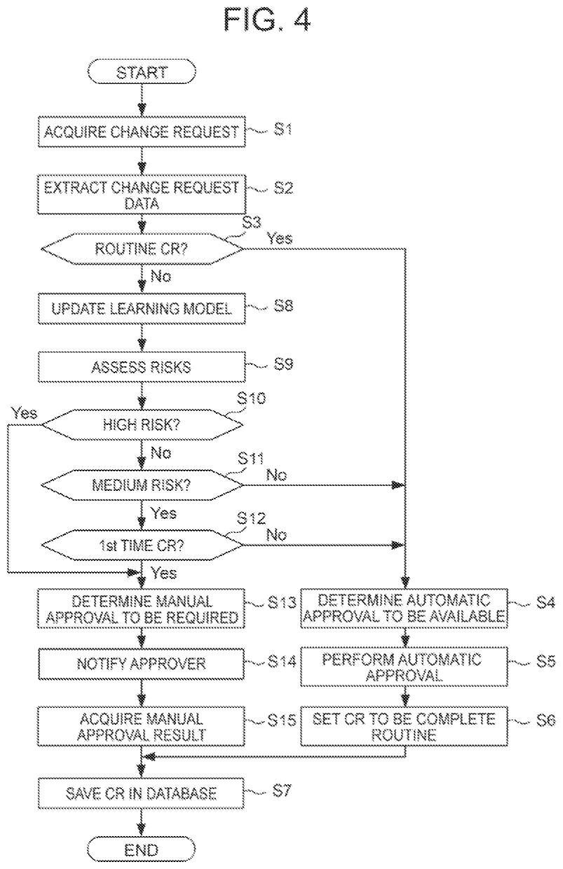

FIG. 4 is a flowchart illustrating an exemplary processing procedure of the network management section 150.

First, in step S1, the network management section 150 acquires a change request.

In step S2, the network management section 150 extracts data (i.e., CR data) included in the change request. Here, the CR data is information necessary for determining whether or not the acquired change request is the routine CR, and information necessary for assessing the risk of the acquired change request.

In step S3, the network management section 150 determines, based on the data acquired in step S2, whether or not the change request acquired in step S1 is the routine CR. Hereinafter, an exemplary case will be described in which the network management section 150 uses a learning model (e.g., AI model) to determine whether or not the change request acquired in step S1 is the routine CR.

In this step S3, using the learning model, the network management section 150 may determine whether or not the change request acquired in step S1 is the same as or similar to a previously acquired change request, and when the change request is determined to have been previously acquired, the network management section 150 may further determine whether or not an approval has been previously performed for the previously acquired change request.

Subsequently, when the network management section 150 determines that the acquired change request is the same as or similar to a change request that has been acquired and approved previously, in other words, the acquired change request is the routine CR, the processing proceeds to step S4. On the other hand, when the network management section 150 determines that the acquired change request is not the routine CR, the processing proceeds to step S8.

Here, the learning model may be a model that has learned the data structure of all change requests acquired so far. The above learning model may be a model that has learned the patterns of change requests that have been previously acquired and the types of change requests for which approvers have performed approvals. The above learning model may be a machine learning model, such as a neural network.

It should be noted that, although an exemplary case will be described here in which a learning model is used to determine whether or not a change request is the routine CR, the ways of determining whether or not a change request is the routine CR is not limited thereto.

As described above, the network management section 150 may refer to the database 150a based on the information included in the acquired change request to determine whether or not the acquired change request is the routine CR. When the change request is configured to include information already indicating that the change request concerned is the routine CR (e.g., a flag), the network management section 150 may also use the above information included in the change request to determine that the acquired change request is the routine CR.

The ways of determining whether or not the acquired change request is the routine CR may be set as appropriate according to the specification and complexity of the data structure of change requests.

In step S4, the network management section 150 determines that the change request acquired in step S1 is the routine CR, in other words, the acquired change request is a change request that can be automatically approved, and the processing proceeds to step S5.

In step S5, the network management section 150 performs the automatic approval for the change request acquired in step S1.

In step S6, the network management section 150 sets the change request acquired in step S1 as a complete routine CR that has been previously approved and may be automatically approved from the next time without notifying the approver of the change request. For example, the network management section 150 may manage routine CRs by, for example, setting flags.

In step S7, the network management section 150 stores the change request acquired in step S1, and the determination results of the automatic approval for the change request in an associated manner, in the database 150a.

In step S8, the network management section 150 updates the learning model based on the information included in the change request acquired in step S1. In other words, in step S8, the network management section 150 causes the learning model to learn the data structure of change requests that are non-routine CRs from among the change requests acquired in step S1.

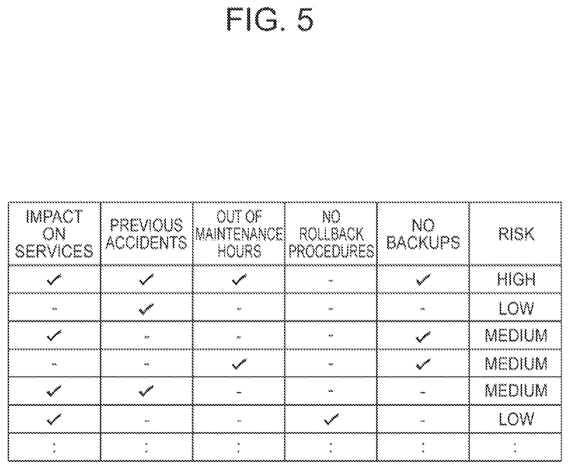

In step S9, the network management section 150 assesses the risk of the change request acquired in step S1. The network management section 150 may assess the risk, for example, in three levels: high risk, medium risk, and low risk, based on a risk assessment table shown in FIG. 5.

According to the present embodiment, the network management section 150 assesses the risk based on the following factors: the impact of implementing the change on services, previous accidents or cases caused by implementing the change, the time of day when the change is to be implemented, the availability of a rollback function, and the availability of backups.

Referring to FIG. 5, “impact on services” indicates whether or not implementing the change will affect services, with “✓” indicating that the change will affect services, while “-” indicating that the change will not affect services. Here, the impact on services includes, for example, service outages.

In FIG. 5, “previous accidents” indicates whether or not there are previous accidents or cases caused by implementing the change, with “✓” indicating that there have been previous cases, while “-” indicating that there have been no previous cases.

Furthermore, in FIG. 5, “out of maintenance hours” indicates whether or not the time period during which the change is to be implemented is out of maintenance hours, with “✓” indicating out of maintenance hours, while “-” indicating within maintenance hours. Here, maintenance hours may be, for example, the time period from 22:00 to 4:00.

Yet furthermore, in FIG. 5, “no rollback procedures” indicates whether or not a rollback procedure has been established, with “✓” indicating that no rollback procedure has been established, while “-” indicating that a rollback procedure has been established.

Likewise, in FIG. 5, “no backups” indicates whether or not backup is available, with “✓” indicating that there is no backup available, while “-” indicating that backup is available.

It should be noted that, in FIG. 5, only some of conceivable combination patterns are shown. Also, the risk assessment table shown in FIG. 5 is no more than an example only, and conditions to be used for risk assessment and the results of risk assessment are not limited to the conditions and results shown in FIG. 5.

In addition, although the present embodiment describes exemplary cases in which the risk is assessed using the risk assessment table as shown in FIG. 5, the ways of risk assessment is not limited thereto. For example, the network management section 150 may assess the risk using a learning model or the like.

Referring back to FIG. 4, in step S10, the network management section 150 determines whether or not the risk assessed in step S9 is high, and when it is determined that the risk is not high, the processing proceeds to step S11, and when it is determined that the risk is high, the processing proceeds to step S13.

In step S11, the network management section 150 further determines whether or not the risk assessed in step S9 is medium, and when it is determined that the risk is not medium, in other words, the risk is low, the processing proceeds to step S4, and when it is determined that the risk is medium, the processing proceeds to step S12.

In step S12, the network management section 150 determines whether or not the change request acquired in step S1 is the first CR, and when it is determined that the change request is the N^{th} CR, the processing proceeds to step S4, and when it is determined that the change request is the first CR, the processing proceeds to step S13.

In step S13, the network management section 150 determines that the change request acquired in step S1 is a change request requiring that a manual approval needs to be performed, and the processing proceeds to step S14.

In step S14, the network management section 150 notifies the approver of the contents of the change request acquired in step S1.

In step S15, the network management section 150 acquires the result of the manual approval by the approver, and the processing proceeds to step S7.

As described above, depending on the combination of the results of the determination of whether or not the acquired change request is the routine CR and the results of the risk assessment, the network management section 150 is able to determine whether to perform the automatic approval of the change request or to notify the approver of the change request.

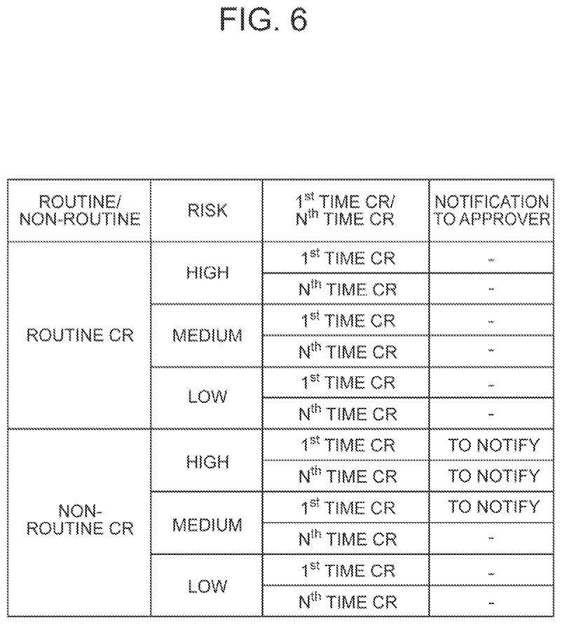

FIG. 6 is a schematic diagram illustrating exemplary patterns of notification to approvers.

In FIG. 6, “routine/non-routine” indicates whether the change request is the routine CR or the non-routine CR.

In FIG. 6, “first/N^{th} CR” indicates whether the change request is the first CR, which has never been requested previously, or the N^{th} CR, which has been previously requested.

Furthermore, in FIG. 6, “notification to approvers” indicates whether or not the change request needs to be notified to approvers, with “to notify” indicating that the notification is required, and “-” indicating that the notification is not required.

As shown in FIG. 6, a change request that is classified into the routine CR is determined to be a change request that is to be automatically approved and does not require the notification to the approver, regardless of the risk assessment results (i.e., high risk, medium risk, or low risk).

On the other hand, for a change request that is classified into the non-routine CRs, it is determined whether to perform the automatic approval or notify the approver depending on the risk assessment results. More specifically, when the risk of the change request is low, it is determined that the notification is not required, on the other hand, when the risk of the change request is high, it is determined that the notification is required. When the risk of the change request is medium, it is determined whether to perform the automatic approval or notify the approver depending on whether or not the change request is the first CR. More specifically, when the change request is the N^{th} CR, which has been previously requested, it is determined that no notification is required, on the other hand, when the change request is the first CR, it is determined that the notification is required.

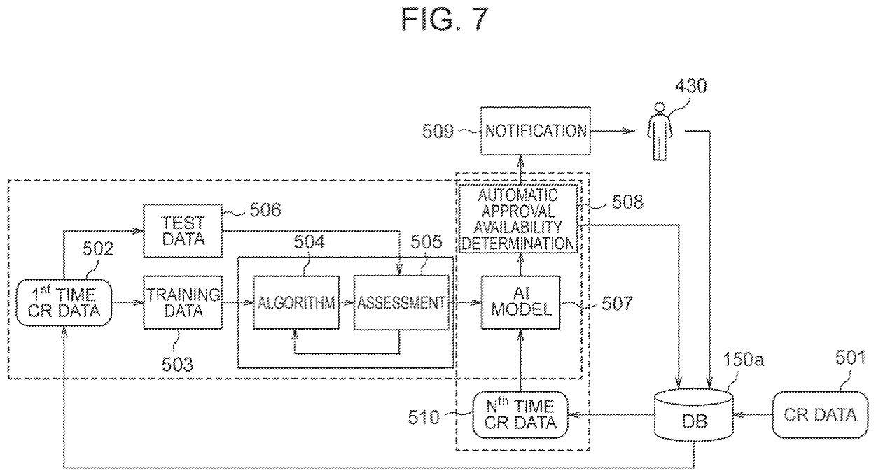

FIG. 7 is a schematic diagram illustrating an exemplary flow of the automatic approval determination processing using the learning model (i.e., AI model).

When a change request is acquired, the network management section 150 extracts data (i.e., CR data) 501 included in the change request. The extracted CR data 501 is stored in the database (DB) 150a.

When the acquired change request is the first CR, which has never been previously acquired, the network management section 150 may determine, based on the first CR data (1^{st} time CR data) 502, the change request concerned to be the first CR, using the AI model 507, which will be described below.

In this case, the network management section 150 performs the automatic approval availability determination 508 that assesses the risk of the acquired change request and determines whether or not to perform the automatic approval according to the results of the risk assessment. More specifically, the network management section 150 determines to perform the automatic approval when the risk is low, and determines not to perform the automatic approval when the risk is medium or high.

When it is determined to perform the automatic approval, the network management section 150 stores the result of such determination in the database 150a and performs the automatic approval. On the other hand, when it is determined not to perform the automatic approval, the network management section 150 notifies an approver 430 of the acquired change request (i.e., notification 509). The result of a manual approval by the approver 430 is then stored in the database 150a.

Also, when the acquired change request is the first CR, the network management section 150 may constitute the AI model 507 based on the first CR data 502. More specifically, the network management section 150 uses the training data 503, which is extracted from the first CR data 502, and utilizes machine learning algorithms 504 to train the AI model 507 so as to allow the AI model 507 to learn the data structure of the change request. The network management section 150 may also allow the AI model 507 to learn whether the change request has been approved or rejected. At this time, the network management section 150 performs training, assessment, and tuning iteratively to optimize the AI model 507. Here, the assessment 505 is performed using test data 506 extracted from the first CR data 502.

On the other hand, when the acquired change request is the No, CR which has been previously acquired, the network management section 150 may determine, based on the N^{th} CR data (N^{th} time CR data) 510, that the change request concerned is the N^{th} CR using the AI model 507.

Subsequently, when the acquired change request is the routine CR which has been previously approved, the network management section 150 determines to perform the automatic approval by the automatic approval availability determination 508, stores the determination results in the database 150a, and performs the automatic approval.

On the other hand, when the acquired change request is a non-routine CR which has never been approved previously, the network management section 150 assesses the risk of the acquired change request by the automatic approval availability determination 508, and determines whether or not to perform the automatic approval according to the results of the risk assessment. More specifically, when the risk is low or medium, it is determined to perform the automatic approval, while when the risk is high, it is determined not to perform the automatic approval.

Then, when it is determined to perform the automatic approval, the network management section 150 stores the result of such determination in the database 150a to perform the automatic approval. On the other hand, when it is determined not to perform the automatic approval, the network management section 150 notifies the approver 430 of the acquired change request (i.e., notification 509). The result of the manual approval by the approver 430 is then stored in the database 150a.

As described above, the network management unit 150, which serves as the network management apparatus according to the present embodiment, acquires a change request that describes information on the contents of a change plan relating to the network configuration, and determines, based on the information included in the acquired change request, whether or not to perform an automatic approval that automatically approves the change request without notifying an approver of the change request. For change requests for which the automatic approval is not determined to be performed, the network management section 150 further determines whether or not to perform the automatic approval based on the result of risk assessment of implementing the change in accordance with the change request.

Thus, the network management section 150 is able to automatically determine whether or not to perform an approval of the change request based on the information included in the submitted change request. As a result, it makes it possible to significantly reduce the time and labor which are otherwise required to determine whether or not to approve a change request.

Furthermore, the network management section 150 performs determination in two stages: the first determination, which determines whether or not to perform the automatic approval based on the information included in the change request (e.g., CR data patterns), and the second determination, which determines whether or not to perform the automatic approval based on the risk of implementing the change in accordance with the change request. This way, it makes it possible to appropriately determine whether or not to perform the automatic approval. As a result, it makes it possible to suppress network failures caused due to human error in approving change requests.

Yet furthermore, the network management section 150 is able to perform the automatic approval for change requests for which the automatic approval is determined to be performed, and notify an approver of the change request regarding change requests for which the automatic approval is determined not to be performed.

In this way, for change requests for which the automatic approval is determined to be performed, it makes it possible to automatically perform the approval without human intervention so as to eliminate approvers' labor in approving change requests. Also, for change requests for which the automatic approval is determined not to be performed, it makes it possible to notify approvers of the change request so as to prompt approvers to manually approve the change request.

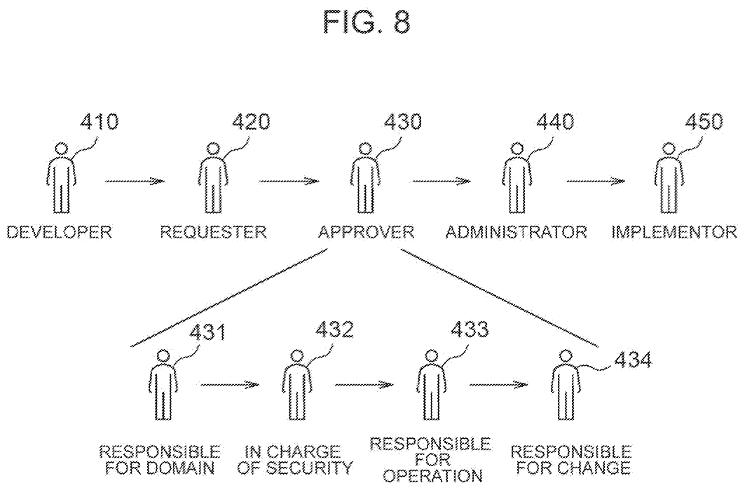

As shown in FIG. 8, conventionally, when making changes such as repairing or replacing devices or functions in the production environment, many people have been involved in the processes from submitting a change request to implementing the change. First, the developer 410 prepares the operating procedure documents related to the change to cause the requester 420 to submit the change request. The requester 420 submits the change request and asks the approver 430 for an approval.

The approver 430 checks or confirms the submitted change request and approves or rejects the change request by assessing the risks associated with the change and determining whether or not the contents and procedures of the change are appropriate. Here, multiple approvers are involved in the approval of a change request in order to perform multifaceted verification from various perspectives. For example, the approval of a change request may involve a person responsible for domain 431, a person in charge of security 432, a person responsible for operations 433 and a person responsible for changes 434, and the approval is performed in multiple stages by those multiple approvers.

When the change request is approved by the approver 430, the approved change request is then sent to the administrator 440. The administrator 440 conducts a final confirmation on the change request and instructs the implementor 450 to implement the change. The implementor 450 implements the change and verifies that the change has been successfully made. Thus, multiple teams (e.g., 9 teams in FIG. 8) are involved in the implementation of the change, thereby inevitably requires considerable amount of time for approval.

In addition, in case that the change request is rejected by the approver 430, the change request may need to be submitted again by the requester 42, or an approval by multiple approvers 431 to 434 may be required in order to modify a part or all of the change request. This requires additional time and labor.

As the approval process is time consuming, it may affect overall network activities.

According to the present embodiment, the network management section 150 is able to automatically determine whether to approve the submitted change request or otherwise have an approver approve the submitted change request, and when the change request is determined to be approved, the network management section 150 is able to perform the approval automatically. As a result, it makes it possible to reduce the time and human cost involved in the approval process for change requests. In addition, since changes can be implemented expeditiously, it makes it possible to maintain the production environment in an optimal state.

When the acquired change request is the same as or similar to a change request for which the approval has been previously performed, the network management section 150 may determine that the change request is the routine CR so that the change request is eligible to be automatically approved.

Thus, the network management section 150 is able to check the patterns of the acquired change request, and when the acquired change request has the same pattern as a change request for which the approval has been previously performed, determine to automatically approve the acquired change request without notifying the approver of the acquired change request. Therefore, it makes it possible to easily and appropriately determine whether or not to perform the automatic approval.

For example, the network management section 150 may determine whether or not the acquired change request is the routine CR by referring to the database 150a that stores change requests previously acquired to determine whether or not such a change request is in presence as with the same pattern as the acquired change request and with a flag indicating that an approval has been previously performed.

Furthermore, the network management section 150 may also train the learning model on the change requests for which approvals have been performed, and use the trained learning model to determine whether or not the acquired change request is the routine CR. In this case, even when the change request has a complex data structure, it makes it possible to appropriately determine whether or not the acquired change request has the same pattern as a change request for which approval has been previously performed. In addition, by using a leaning model that learns the data structure of change requests and the results of approvals by approvers, even when, for example, a change request incorrectly includes information indicating that it is the routine CR, it makes it possible to appropriately prevent the change request from being erroneously determined to be the routine CR based on the information.

Furthermore, when it is difficult to determine whether to perform the automatic approval based solely on the information included in the change request, the network management section 150 may determine whether or not to perform the automatic approval based on the results of the risk assessment. The network management section 150 may assess the risk of implementing the change in accordance with to the change request in at least two levels: high risk and low risk. When the risk is low, the network management section 150 may determine to perform the automatic approval of the change request, while when the risk is high, the network management section 150 may determine not to perform the automatic approval of the change request.

In this way, since the decision to perform the automatic approval or not is made based on the risk assessment results, it makes it possible to appropriately suppress network failures due to approval errors from occurring.

Alternatively, the network management section 150 may also assess the risk of implementing the change in accordance with the change request in three levels: high risk, medium risk, and low risk. In this case, when it is difficult to determine whether to perform the automatic approval based solely on the information included in the change request, the network management section 150 may then perform a risk assessment and, when the risk is medium, further determine whether or not the change request is the same as or similar to a change request that has been previously acquired. As a result, when the acquired change request is determined to be the same as or similar to some previous change request, the network management section 150 may determine to perform the automatic approval of the change request. On the other hand, when the acquired change request is determined not to be the same as or similar type of change request, the network management section 150 may determine not to perform the automatic approval of the change request.

In this way, when the risk is medium, the network management section 150 may further determine whether the acquired change request is the first CR or the N^{th} CR, and when the acquired change request is the N^{th} CR, the automatic approval is performed, and when the acquired change request is the first CR, the automatic approval is not performed. In other words, for change requests with medium risk, the approver is always notified the first time, and even when the approver has rejected the approval at the first time, the automatic approval can be performed the second and subsequent times. Thus, an appropriate decision can be made while taking into account the requester's intention and the risk.

The network management section 150 may assess the risks described above based on at least one of the following, namely, impact of implementing the change on services, previous accidents or cases caused by implementing the change, the time of day when the change is to be implemented, the availability of the rollback function, and the availability of backups. As a result, it makes it possible to appropriately assess the risks associated with changes.

As described above, according to the present embodiment, it makes it possible to reduce the time and human cost required for approval of change requests in a large-scale network. Furthermore, according to the present embodiment, it makes it possible to automatically and expeditiously approve change requests.

The network management apparatus according to the present embodiment may be implemented in any of general-purpose servers that constitute the backhaul network, the core network, or the like, of the mobile network 100. Alternatively, the network management apparatus may be implemented in a dedicated server. The network management apparatus may also be implemented on a single or a plurality of computers.

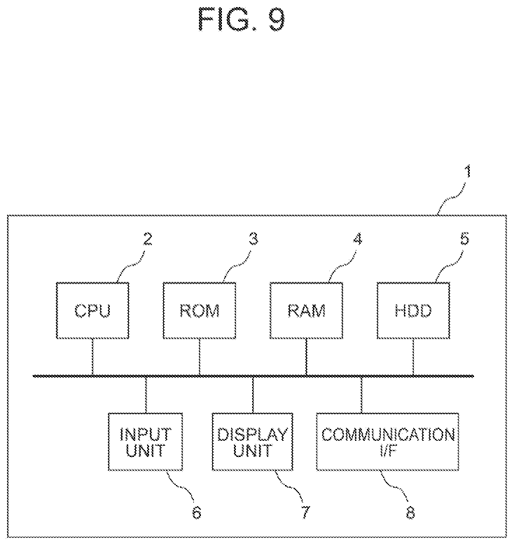

When the network management apparatus is implemented on a single computer, as shown in FIG. 9, the network management apparatus 1 may include a CPU 2, a ROM 3, a RAM 4, an HDD 5, an input unit 6, a display unit 7, a communication I/F 8, and the like.

The CPU (Central Processing Unit) 2 controls entire operations of the network management apparatus 1 in a comprehensive manner, and controls the operations of respective components 3 to 8 via a system bus, which serves as a data transmission path.

The ROM (Read Only Memory) 3 is a non-volatile memory that stores the control programs and the like necessary for the CPU 2 to execute the processing. Those programs may be stored in an external memory, for example, a non-volatile memory such as an HDD (Hard Disk Drive) 5, an SSD (Solid State Drive), or a removable storage medium (not shown).

The RAM (Random Access Memory) 4 is a volatile memory and functions as a main memory, a work area, or the like of the CPU 2. In other words, the CPU 2 loads the necessary programs and the like from the ROM 3 into the RAM 4 and executes the programs to realize various functional operations.

The HDD 5 stores, for example, various data and information necessary for the CPU 2 to perform processing using the programs. In addition, the HDD 5 stores, for example, various data and various information and the like obtained by the CPU 2 performing the processing using the programs and the like.

The input unit 6 is constituted with a pointing device such as a keyboard or a mouse, or the like.

The display unit 7 is constituted with a monitor such as a liquid crystal display (LCD). The display unit 7 may provide a GUI (Graphical User Interface) that is used to input instructions to the network management apparatus 1 for various parameters and communication parameters used in communication with other devices, or the like.

The communication I/F 8 is an interface that controls communication between the network management apparatus 1 and external devices.

The functions of at least some of the components of the network management section 150 shown in FIG. 3 may be realized by the CPU 2 executing the programs. However, at least some of the functions of the components of the network management section 150 shown in FIG. 3 may be operated by a dedicated hardware. In this case, operation of the dedicated hardware is under the control of the CPU 2.

Although certain embodiments have been described above, the embodiments described are merely illustrative and are not intended to limit the scope of the present invention. The apparatus and methods described herein may be embodied in other forms than those described above. In addition, without departing from the scope of the present invention, omissions, substitutions, and modifications may be made to the above embodiments as appropriate. Such omissions, substitutions, and modifications fall within the scope of the appended claims and equivalents thereof, and fall within the technical scope of the present invention.

### REFERENCE SIGNS LIST

11: Base Station; 12: Edge Data Center; 13: Regional Data Center; 14: Central Data Center; 100: Mobile Network; 110: NFVI; 120: VNF; 130: MANO; 131: NFVO; 132: VNFM; 133: VIM; 140: OSS/BSS; 150: Network Management Section; 150a: Database; 151: Change Request Acquisition Unit; 152: Routine Determination Unit; 153: Risk Assessment Unit; 154: Approval Type Determination Unit; 155: Approval Performing Unit; 156: Notification Unit

1. A network management apparatus, comprising:
at least one memory configured to store program code; and
electronic circuitry including at least one processor, the at least one processor being configured to read and operate according to the program code, the electronic circuitry configured to:
acquire a change request that describes information on contents of a change plan relating to a network configuration;
determine, based on the information included in the change request, whether or not to perform an automatic approval that approves the change request without notifying an approver of the change request;
assess, based on the information included in the change request, a risk of implementing a change in accordance with the change request; and
determine whether or not to perform the automatic approval based on the risk with respect to the change request for which the automatic approval has not been determined to be performed.

2. The network management apparatus according to claim 1, the electronic circuitry further configured to:
perform an approval of the change request for which the automatic approval is determined to be performed; and
notify an approver of the change request for which the automatic approval has been determined not to be performed.

3. The network management apparatus according to claim 1, wherein
determining based on the information determines to perform the automatic approval when the change request is the same as or similar to a change request for which approval has been performed previously.

4. The network management apparatus according to claim 1, the electronic circuitry further configured to:
train a learning model to learn the change request for which the approval has been performed, and
determining based on the information determines whether or not to perform the automatic approval using the trained learning model.

5. The network management apparatus according to claim 1, wherein
assessing the risk assesses the risk in at least two levels: high risk and low risk, and
determining based on the risk determines to perform the automatic approval when the risk level of the change request for which the automatic approval has not been determined to be performed is low risk, and
determines not to perform the automatic approval when the risk level of the change request for which the automatic approval has not been determined to be performed.

6. The network management apparatus according to claim 1, wherein
assessing the risk assesses the risk in three levels: high risk, medium risk, and low risk, and
when the risk level of the change request for which the automatic approval has not been determined to be performed is medium risk, determining based on the risk further determines whether or not the change request is the same as or similar to a change request that has been previously acquired, and
determines to perform the automatic approval when the change request is determined to be the same as or similar to the change request that has been previously acquired, and
determines not to perform the automatic approval when the change request is determined to be neither the same as nor similar to the change request that has been previously acquired.

7. The network management apparatus according to claim 1, wherein
assessing the risk assesses the risk based on at least one of the following: an impact of implementing the change on a service, time of day when the change is implemented, availability of a rollback function, and availability of backups.

8. A network management method performed by a network management apparatus, comprising:
an acquiring step of acquiring a change request that describes information on contents of a change plan relating to a network configuration;
a first determination step of determining, based on the information included in the acquired change request, whether or not to perform an automatic approval that approves the change request without notifying an approver of the change request;
an assessment step of assessing, based on the information included in the acquired change request, a risk of implementing a change in accordance with the change request; and
a second determination step of determining whether or not to perform the automatic approval based on the risk assessed in the assessment step with respect to the change request for which the automatic approval has not been determined to be performed in the first determination step.

9. A network management system, comprising:
at least one memory configured to store program code; and
electronic circuitry including at least one processor, the at least one processor being configured to read and operate according to the program code, the electronic circuitry configured to:
acquire a change request that describes information on contents of a change plan relating to a network configuration;
determine, based on the information included in the change request, whether or not to perform an automatic approval that approves the change request without notifying an approver of the change request;
assess, based on the information included in the change request, a risk of implementing a change in accordance with the change request; and
determine whether or not to perform the automatic approval based on the risk with respect to the change request for which the automatic approval has not been determined to be performed.
